(19) United States
(12) Patent Application Publication
(10) Pub. No.: US 2018/0348750 A1
(43) Pub. Date: Dec. 6, 2018

(54) Enhanced teleoperation of unmanned ground vehicle

(71) Applicant: Quantum Signal LLC, Saline, MN (US)

(72) Inventors: Robert M. Lupa, Saline, MI (US); Sean D. Eye, Ypsilanti, MI (US); Karl D. Iagnemma, Washington, DC (US); Mitchell M. Rohde, Saline, MI (US)

(21) Appl. No.: 15/821,810

(22) Filed: Nov. 23, 2017

Related U.S. Application Data
(60) Provisional application No. 62/425,851, filed on Nov. 23, 2016.

(51) Int. Cl. G05D 1/00; G06K 9/00; G06K 9/32; H04N 19/17; H04W 4/40; H04L 1/00

(52) U.S. Cl. CPC G05D 1/0038; G05D 1/0044; G05D 1/0088; G06K 9/00791; G05D 2201/0213; H04N 19/17; H04W 4/40; H04L 1/0011; G06K 9/3233

(57) ABSTRACT

Unmanned ground vehicle teleoperation is provided. A forward looking scene understanding system is employed. Region of interest based compression is employed. Driving specific scene virtualization is employed. Link quality measurement is employed. A hared control autonomy system is used.

### BACKGROUND

Teleoperation is the remote control of a vehicle over a communications link.

### BRIEF DESCRIPTION OF THE DRAWINGS

FIGS. 1, 2, 3, and 4 are diagrams depicting various examples of the invention.

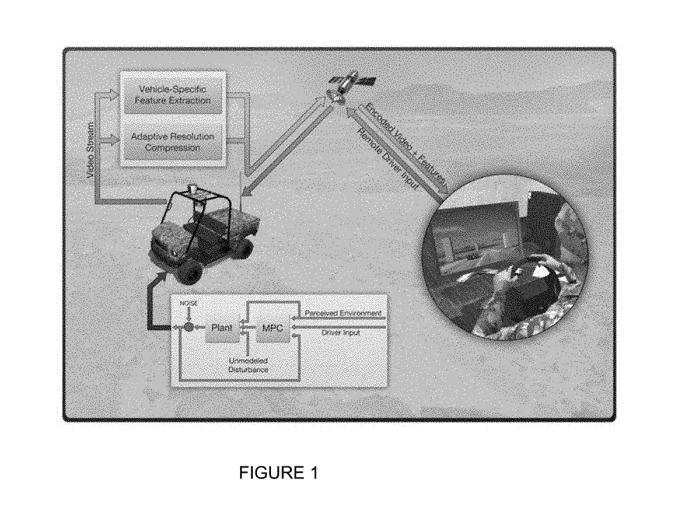

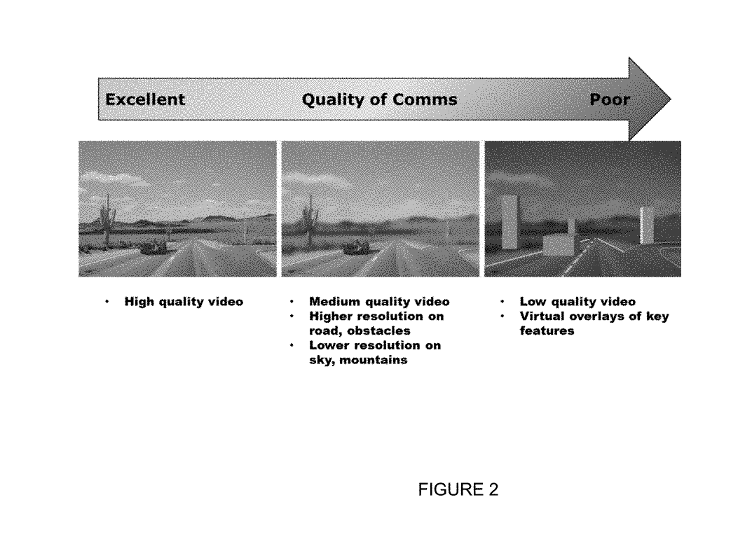

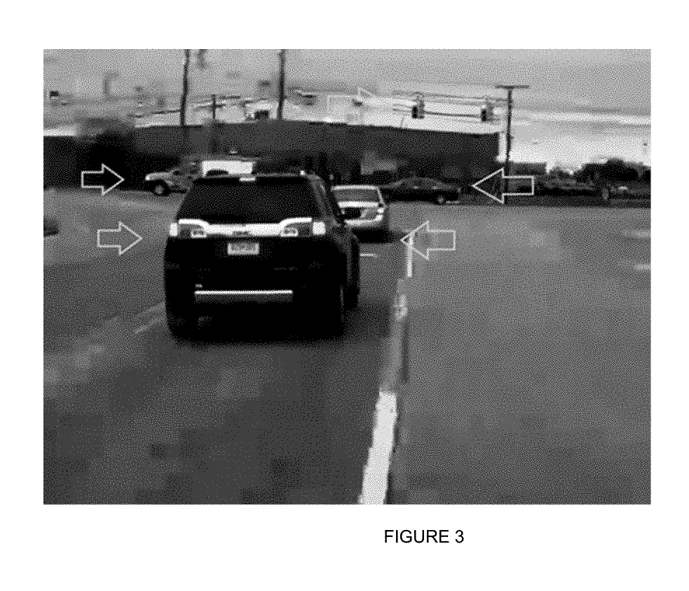

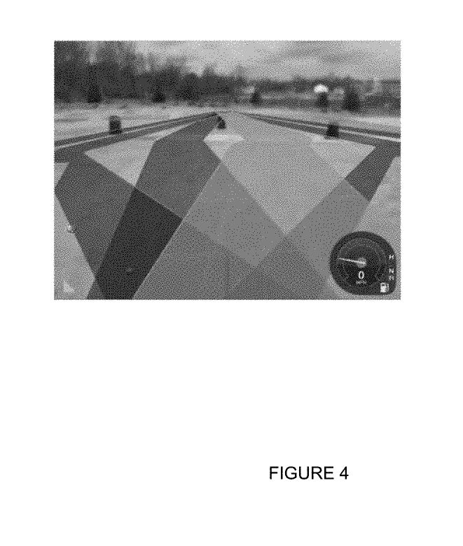

### DETAILED DESCRIPTION

An embodiment of the invention improves teleoperation (remote control over a communications link) of unmanned ground vehicles (UGVs). Teleoperators (those remotely controlling the vehicle) often have difficulties while performing tasks with the UGV as a result of non-idealities of the communications link. These non-idealities include the bandwidth of the linkage, with lower bandwidths limiting the amount of information (on vehicle state and surrounding environment) that can be transmitted back to the teleoperator. They also include variable temporal delays that can disrupt the ability to control the vehicle in a manner that is temporally appropriate—particularly when the vehicle is teleoperated at higher speeds. An embodiment of the invention overcomes these issues and maintains a stable, effective, efficient teleoperation system independent of these non-idealities. It does so by using a combination of technologies:

Forward looking scene understanding system—using sensors (cameras, lidars, radars, etc) that look forward in the path of the vehicle and image processing algorithms, one extracts scene elements that are relevant/key to the driving task. Such elements include road surface area, road edges, lane markings, obstacles, road signs, other vehicles, etc. This scene understanding technology runs onboard the UGV.

“Region of interest” based compression—a digital image/video compression algorithm that is applied to video from the UGV that is to be compressed onboard the UGV, transmitted over a communications link, and then decompressed on the operator control unit (OCU) and represented to the teleoperator. This algorithm uses information from the scene understanding algorithm to allocate resolution in the imagery; areas of the images that contain the elements key to driving (“regions of interest”) are compressed, transmitted, and decompressed at a higher quality than other areas of the image that contains background or other information non-critical to the driving task. In this way a communications linkage of a given bandwidth is able to carry a stream of video content that facilitates the remote driving task in a manner better than could be provided by a standard, non-ROI compression methodology. The compression end of this technology runs onboard the UGV and the decompression end runs at the OCU.

Driving Specific Scene Virtualization—another type of compression algorithm that also leverages the scene understanding system. The features from the scene understanding system, and their relative geometry, are described and saved in a specialized format. This format is extremely compact relative to actual video data, and thus can be transmitted at a much lower bandwidth than the equivalent video. The virtualized data is transmitted over a link, and then recomposed as a visual scene to be viewed by the teleoperator at the OCU using a graphical scene representation engine. This UGV driving specific system allows teleoperation when bandwidth is too small for live video of sufficient quality to drive. The compaction end of this technology runs onboard the UGV and the recomposition end runs at the OCU.

Link quality measurement—an algorithm that monitors communication link quality between the OCU and UGV. This algorithm measures both the bandwidth and latency of the channel, and is used to inform other pieces of the overall system. This component runs onboard both the OCU and UGV. Perception scaling system—the purpose of this system is to determine the type/mix of visual representation provided to the operator on the OCU. Using the link quality measurement system output, a set of vehicle/implementation specific pre-determined thresholds, and input provided by the teleoperator through the OCU controls, the system determines the mixture of general level of video compression, ROI quality and virtualized scene representation content that will be presented to the teleoperator. For instance, when a high quality (high bandwidth, low latency) link is available, the system may provide primarily high-resolution streaming video. Alternately, when a low quality (low bandwidth, high latency) link is available, the system may provide primarily virtualized representations and little/no video. Mixtures of compressed video, video with augmentive overlays, and other states that fall “in between” full video and full virtualization are possible with this system. In this manner the overall system can automatically scale and adapt to provide effective teleoperation visualizations under different link qualities.

“Shared Control” autonomy system—this subsystem augments the manual teleoperated control affected by the teleoperator. The system uses the output of the scene understanding system, the link quality measurement system, an estimate of vehicle position and input from the teleoperator in conjunction with a dynamics model of the vehicle to algorithmically determine if and when the system should take over control of the vehicle. If the link quality becomes temporarily too low (e.g. high latency or extremely low bandwidth) or drops out completely, this subsystem can maintain control and ensure the vehicle doesn't collide with an obstacle. The system also monitors and takes over control when the situation is such that vehicle stability/safety is threatened and the teleoperator may have difficulty executing an evasive maneuver in a timely or controlled fashion. The shared control system runs onboard the UGV.

An embodiment of the invention is comprised of an architecture and system that combines the subsystems listed above with a “standard” teleoperation system to yield an enhanced system that can (at some level) overcome the non-idealities listed earlier. Portions of the system have been prototyped under a US government grant. An embodiment of the invention is innovative and suitable for patent protection in at least the following areas:

The overall architecture is innovative. The combination of technologies leading to a solution for UGV teleoperation is unique.

The region of interest based compression, as specific to ground vehicle driving tasks, is innovative and unique.

The driving specific scene virtualization is new and unique.

The concept of a perception scaling system that fuses multiple inputs, measurements, and settings to determine where, on a scale from real video to completely virtual representation, the representation to the teleoperator should be, is unique and innovative.

The hybridization of scaled perception/appearance with a shared autonomy system for teleoperation is unique and innovative.

The inventive components are divided between two platforms; a segment of an embodiment of the invention runs on the target vehicle (the “UGV”) and the other segment runs on an operator control unit (OCU). An embodiment of the invention works in the following manner:

Sensors onboard the vehicle, such as cameras, LIDARs, RADARs, GPS, and similar exist onboard the vehicle, and aim at areas in front of and surrounding the vehicle. These sensors collect data on the environment through which the vehicle travels as well as about the state of the vehicle itself (position, speed, etc.). The data is monitored in real-time by a number of algorithms, implemented in software, and running on hardware onboard the vehicle.

Several processes running onboard the vehicle monitor the sensor data, using it in one or more of several ways:

The sensor data is used to estimate the position of the vehicle in space within its operating environment. This includes geoposition, “pose”, and similar. This position and pose estimation is continuously updated in real-time.

The sensor data is used to extract the locations of obstacles relative to the vehicle, which is in turn used to generate an obstacle map. This map is continually updated in real-time.

The sensor data is used to extract and identify portions of the observed scene that are relevant to the remote driving task. For example, these portions (or, “regions of interest”) can include roadway edges, other vehicles, observed signs, traffic lights, or other elements. This scene analysis is continually updated in real-time.

The sensor data is also used to sense the dynamics and kinematics of the vehicle—how it is moving through space. That information is used in conjunction with an internal mathematical model of the vehicle, which estimates stability in conjunction with planned inputs (see later section) and estimates “corridors of safety” through which the vehicle can travel. This dynamic/kinematic estimation is continuously updated in real-time.

Simultaneous with the onboard sensing described above, a process that runs onboard both the UGV and OCU continuously monitors and estimates the quality of the communications link between the two. The quality measurement includes live, continuous estimates of bandwidth, latency, noise, dropouts, and related factors.

Based on the detected quality of the communication channel, as well as other preference settings, the system will compress and transmit differing types of data from the UGV over the communications link to the OCU. This data enables the operator at the OCU to perceive the state of the vehicle and its surroundings, and assist them in piloting the vehicle through it. The form of the data and compression varies, but can include:

Live, “region of interest” (ROI) compressed video—the system will take the identified regions of interest in the scene and use them as the basis upon which to segment the live video frames/areas for compression purposes. Areas that are of interest are less heavily compressed, while areas that are not of interest (such as background) are more heavily compressed. This yields a substantial reduction in the amount of data required to represent frames of video, and by extension the amount of bandwidth required to transmit real-time video from UGV to OCU while maintaining sufficient quality for the driving task.

Live, reduced scene representations—the system will take the scene data, obstacle map, regions of interest and similar and create a mathematically reduced representation of that scene. This reduced representation yields a substantial reduction in the amount of bandwidth required to transmit a visualization of the surroundings from UGV to OCU while maintaining sufficient quality for the driving task.

Mixtures of visualizations—depending upon the communication quality, the system may leverage some combination of compressed video, reduced scene representations, or a visual mixture of the two. This mixture is determined such that only the data required for the mixture need be transmitted from the UGV to the OCU. Of course, the data transmitted from UGV to OCU depends upon communication link characteristics and the determination of the “fidelity selector.”

Other performance and state data—this includes data such as vehicle state, vehicle settings, indications of ambient conditions, environmental and terrain data, “meta” data created above (such as obstacle maps), and similar.

The selection of what data is/isn't transmitted is determined by the “fidelity selector” component, which is software that runs in real time on the UGV. The fidelity selector uses the output of the communications link monitoring component, a pre-determined set of thresholds, and one or more algorithmic approaches (decision tree, fuzzy logic, neural network, etc.) to determine the type, quality, refresh rate, and other parameters of the data (particularly the visualization) to be transmitted in real-time from UGV to OCU.

At the OCU, the system provides an interface between the human user and the rest of the system, presenting information on vehicle state as well as acting as an input area for the user to be able to pilot the vehicle. An embodiment of the invention includes processes running onboard the OCU that:

Monitor communications quality (as mentioned earlier).

Decompresses ROI compressed video that it receives, and incorporates that video as part of the display to the operator.

Decompresses the reduced scene data that it receives, renders it into a visual representation, and then incorporates the representation as part of the display to the operator.

Receive and display “corridors of safety” information to the operator on a visual display, so the operator can use these corridors as guidance while teleoperating. (See Karl patents)

Includes an interface designed to accommodate multiple types of visualizations, separately or overlaid together.

Receive input from the user (such as steering, brake, and throttle commands), convert them into an appropriate data stream, and transmit them back to the UGV in real time.

An embodiment of the invention also incorporates a shared control system which intervenes when the UGV is in danger based on immediate circumstances that the operator cannot react to quickly or safely enough, or that the operator has inadvertently created through their control inputs.

A process onboard the UGV continually, in real-time, monitors the dynamic/kinematic model in conjunction with the obstacle map (computed on the UGV) and operator inputs (received via the communication channel from the OCU). The process estimates level of threat to the vehicle (based on projected paths) as well as postulating alternative, non-colliding routes around the obstacle(s) and the difficulty in maneuvering the vehicle in that manner while maintaining stability.

As part of the same process, the system leverages this threat information and intercedes under certain circumstances:

When the threat to the vehicle exceeds a threshold, and the difficulty of steering the vehicle to avoid that threat exceeds a threshold, the process onboard the UGV ignores the teleoperator input and instead takes over control of the vehicle, steering it out of the way of the threat.

When the threat to the vehicle does not exceed a threshold, or the difficulty of steering the vehicle to avoid the threat is low, the process onboard the UGV allows the teleoperator to continue to control the UGV via the OCU. This process continues to monitor should it need to intervene at any time.

This onboard UGV process also generates estimates of areas (broad paths) through which the vehicle can travel safely forward. These paths are termed “corridors of safety,” and their area definitions (which are compact data) are transmitted back in real-time to the OCU and displayed in conjunction with the visual representations.

Using all of the above, an embodiment of the invention is able to enhance the teleoperation experience in different ways under different communication link conditions. The system adapts to changing communications link conditions along a continuum, maintaining as high quality and real-time a visualization of the environment to the teleoperator as it can. It also continually provides feedback to the operator on safe paths of travel, and interventions when situations dictate and the UGV is threatened. Some examples include:

In the case of a high bandwidth, low-latency communications linkage, the system provides feedback on paths of safe travel and intervenes (via the shared control system) when/if there is a threat to the vehicle that the operator hasn't or can't respond to in a timely fashion.

In the case of high bandwidth, high-latency communications linkage, the system would provide the user high quality video for perception purposes, albeit on a substantial (and potentially varying) delay. The application of the shared control scheme helps to keep the UGV on track and from colliding with an unexpected obstacle even when the latency of the communication link makes it difficult/impossible for the operator to respond in a timely fashion.

In the case of a low bandwidth, low-latency communications linkage, the system is advantageous because it provides a visualization of the driving area in real time that would otherwise be unavailable. Here, a highly virtualized visualization, which requires less bandwidth to transmit, is presented to the teleoperator instead of live video, which is bandwidth intensive. In this condition the teleoperator also benefits from the safe travel corridor feedback, and, to a lesser extent, from the shared intervention.

In the case of a low bandwidth, high-latency communications linkage (the worst case) the system is advantageous because it provides the virtualized visualization (which lowers the amount of bandwidth required for the communication link) and because the travel corridor feedback and shared control help to overcome the latency issue. This is to say that the onboard controls can keep the UGV on track and from colliding with an unexpected obstacle even when the latency of the communication link makes it difficult/impossible for the operator to respond in a timely fashion.

We claim:

1. An unmanned ground vehicle teleoperation system and method.
